(19) United States
(12) Patent Application Publication
(10) Pub. No.: US 2011/0172904 A1
(43) Pub. Date: Jul. 14, 2011

(54) Method of utilizing a personal navigation device to predict paths and related personal navigation device

(76) Inventor: Sajeewa Dayaratne, Auckland (NZ)

(21) Appl. No.: 12/684,976

(22) Filed: Jan. 11, 2010

(51) Int. Cl. G01C 21/36; G08G 1/0969

(52) U.S. Cl. 701/201; 701/207

(57) ABSTRACT

A method of utilizing a personal navigation device to predict paths taken by a user of the personal navigation device includes storing profile data for a user of the personal navigation device in a memory of the personal navigation device, detecting a current path that the user is traveling on when the user has not inputted a destination location into the personal navigation device, determining possible paths that the user may take based on the current path that the user is traveling on, determining a most likely possible path that the user may take according to the profile data for the user, and providing information about upcoming locations related to the most likely possible path.

### BACKGROUND OF THE INVENTION

1. Field of the Invention

The invention relates to path prediction with a personal navigation device, and more particularly, to a method of predicting paths that a user might take according to historical profile data recorded by the personal navigation device.

2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Personal GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken.

In a conventional personal navigation device, a user will input a destination location that he wishes to travel to, such as an office building, a residence, or a tourist attraction. The personal navigation device will then provide navigation instructions to guide the user to the destination location. However, the personal navigation device does not give some types of information, such as point of interest information, to the user unless the user is following an active route after entering the destination location into the personal navigation device.

Since users often do not bother to enter a destination location into the personal navigation device when they are traveling on well known routes, the user may miss out on potentially important information that the personal navigation device could provide if the personal navigation device knows the route that the user is traveling on. Additionally, if the user simply wants to explore the area or drive for fun, he might drive around without entering a destination. Under this situation, the user still needs to know nearby point of interest information or some other form of navigation guidance.

### SUMMARY OF THE INVENTION

It is therefore one of the primary objectives of the claimed invention to provide a way to predict paths taken by a user of the personal navigation device based on historical profile data of the user collected by the personal navigation device. Once the personal navigation device predicts a most likely path that the user will follow, the personal navigation device can offer helpful information or warnings to the user without the user needing to first enter a destination location into the personal navigation device for following an active route.

According to an exemplary embodiment of the claimed invention, a method of utilizing a personal navigation device to predict paths taken by a user of the personal navigation device is disclosed. The method includes storing profile data for a user of the personal navigation device in a memory of the personal navigation device, detecting a current path that the user is traveling on when the user has not inputted a destination location into the personal navigation device, determining possible paths that the user may take based on the current path that the user is traveling on, determining a most likely possible path that the user may take according to the profile data for the user, and providing information about upcoming locations related to the most likely possible path.

According to another exemplary embodiment of the claimed invention, a personal navigation device utilized to predict paths taken by a user of the personal navigation device is disclosed. The personal navigation device includes a memory for storing profile data for a user of the personal navigation device; routing software for detecting a current path that the user is traveling on when the user has not inputted a destination location into the personal navigation device, determining possible paths that the user may take based on the current path that the user is traveling on, determining a most likely possible path that the user may take according to the profile data for the user, and providing information about upcoming locations related to the most likely possible path; and a processor for executing the routing software and for controlling operation of the personal navigation device.

It is an advantage that the present invention automatically collects profile data about the user for helping to predict the most likely path that the user will take according to the profile data. Based on the most likely path that the user will follow, the personal navigation device can offer helpful information or warnings to the user. Therefore, the user can still receive assistance from the personal navigation device without needing to first enter a destination location into the personal navigation device for following an active route. This feature will encourage the user to turn on the personal navigation device as much as possible when traveling, which has the added benefits of increasing the amount of profile data collected about the user as well as increasing the amount of assistance that the personal navigation device can provide to the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a personal navigation device according to the present invention.

FIG. 2 is a flowchart illustrating the present invention method of predicting paths taken by a user according to profile data collected about the user.

FIG. 3 is a map illustrating a path predicted by the routing software of the personal navigation device.

### DETAILED DESCRIPTION

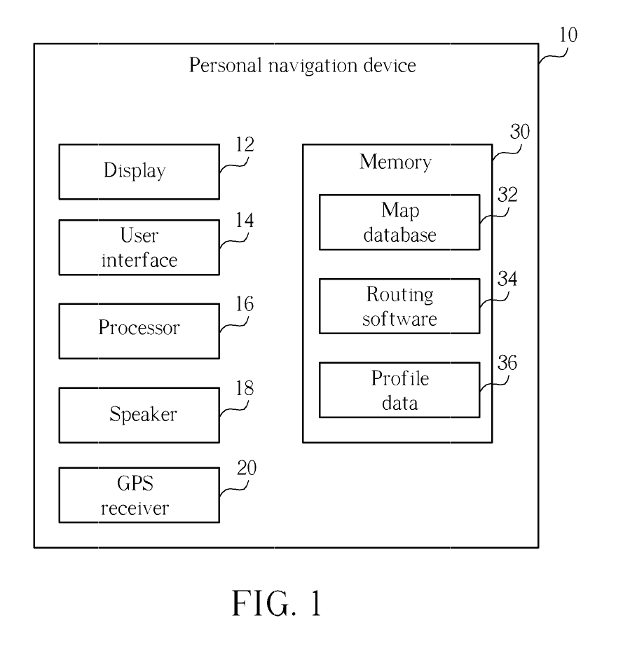

Please refer to FIG. 1. FIG. 1 is a block diagram of a personal navigation device 10 according to the present invention. The personal navigation device 10 contains a display 12 which can be a touch sensitive display, a user interface 14, a processor 16 for controlling operation of the personal navigation device 10, a speaker 18, a GPS receiver 20 for receiving the current coordinates of the personal navigation device 10, and a memory 30. The memory 30 is used to store a map database 32 containing map data and points of interest. The memory 30 also stores routing software 34 as well as profile data 36 about each unique user of the personal navigation device 10. Separate identities or accounts could be utilized in the user interface 14 for users to distinguish themselves in order to build separate profile data 36 for each user.

The present invention personal navigation device 10 helps the user by collecting data about the user's driving habits, storing the data as the profile data 36, predicting paths that a user might take based on the user's current location and current path, and presenting information about upcoming locations and routes based on the data accumulated in the profile data 36 for the user. Differing from the prior art, the user does not need to enter a destination location into the personal navigation device 10 in order for the personal navigation device 10 to offer useful information to the user such as information about upcoming points of interest, upcoming hazards, traffic or road conditions, and so on. This means that the personal navigation device 10 of the present invention offers additional functionality to the user without any extra time or effort on the part of the user.

Information about what paths the user prefers to drive on is determined through the use of the GPS receiver 20 for receiving the current position of the personal navigation device 10 as well as the map database 32 and routing software 34 that are stored in the memory 30. The profile data 36 for the user is then updated to include this information about the user's driving habits. Types of information stored in the profile data 36 include what specific roads the user prefers to travel on. For instance, if the user usually travels on the same roads when leaving the user's home or office, it will become easy to predict this path after enough data has been collected. The profile data 36 also includes information about what types of roads the user prefers. The user may prefer major highways whenever possible, smaller highways, scenic routes, or other types of roads. Other data can also be collected, such as the user's preferred driving speeds on different road segments. As long as the user has the personal navigation device 10 powered on, the personal navigation device 10 can accumulate profile data 36 about the user, even when the user is not following an active route and receiving navigation instructions to a destination location.

After enough profile data 36 has been collected, the routing software 34 can begin to predict a path that the user might take, and can begin to offer relevant information about the path ahead. When predicting a path, the routing software 34 first determines all of the possible paths that the user can take from the user's current location, and then consults the profile data 36 for determining the most likely possible path among all of the possible paths. Then the routing software 34 can consult the map database 32 for providing information about upcoming points of interest, upcoming roads, and upcoming hazards along or in the near vicinity of the most likely possible path. In addition, other kinds of information can be shared with the user, such as traffic alerts or information about traffic conditions related to the most likely possible path. The user can also be warned against speeding by comparing the user's current speed on a particular road segment to speed data stored in the user's profile data 36. If the user's current speed is significantly higher than what is stored in the profile data 36, the personal navigation device 10 can issue a warning to the user.

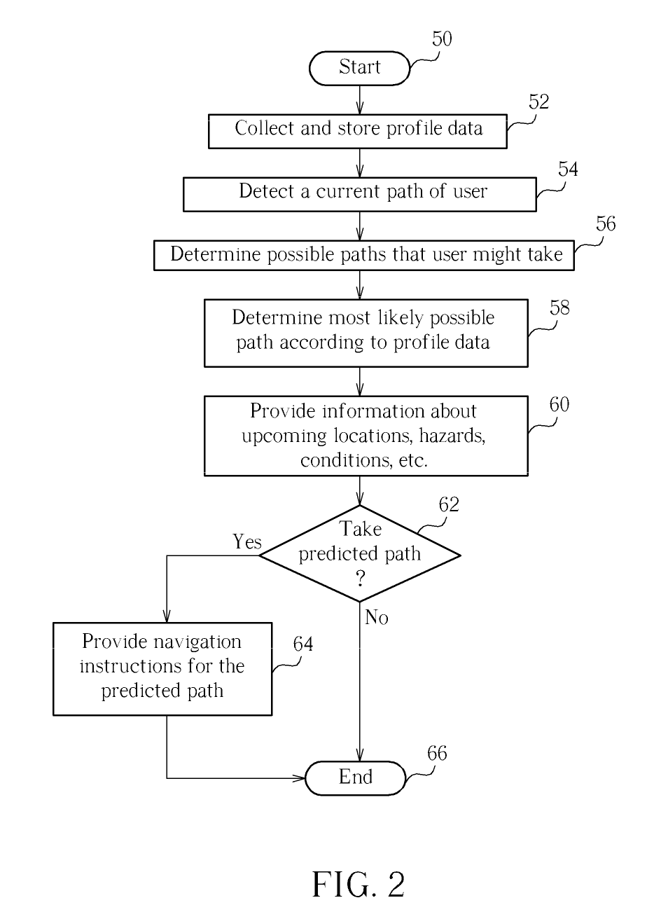

Please refer to FIG. 2. FIG. 2 is a flowchart illustrating the present invention method of predicting paths taken by a user according to the profile data 36 collected about the user. Steps contained in the flowchart will be explained below.

Step 50: Start.

Step 52: Profile data 36 for the user is collected and stored in the memory 30 of the personal navigation device 10.

Step 54: The routing software 34 determines the current path that the user is traveling on based on the current position of the personal navigation device 10 provided by the GPS receiver 20 as well as road information stored in the map database 32.

Step 56: The routing software 34 determines all of the possible paths that the user can take from the user's current location.

Step 58: The routing software 34 searches and analyzes the user's profile data 36 to predict the most likely possible path among all of the possible paths.

Step 60: Provide information to the user about upcoming points of interest, roads, and hazards, as well as traffic information. Warnings can also be given if a user's speed is much greater than the speed stored in the profile data 36 for a given road segment.

Step 62: The personal navigation device 10 asks if the user wishes to take the predicted path. If so, go to step 64. If not, go to step 66.

Step 64: The routing software 34 provides navigation instructions for guiding the user along the predicted path.

Step 66: End.

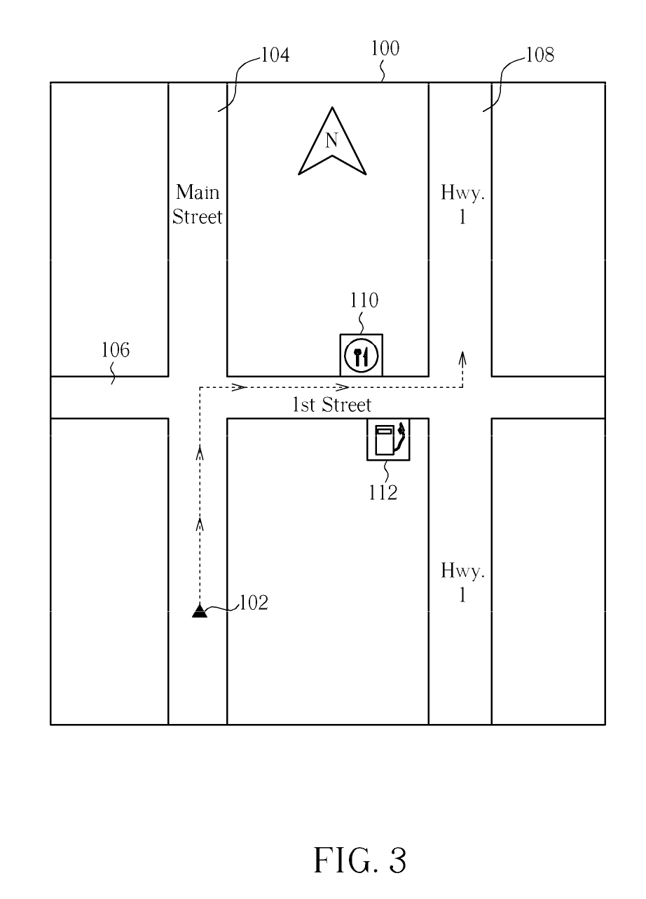

Please refer to FIG. 3. FIG. 3 is a map 100 illustrating a path predicted by the routing software 34 of the personal navigation device 10. As shown in the map 100, an arrow 102 indicates the user's current location. The user is driving north on Main Street 104, and has not entered a destination location into the personal navigation device 10. However, based on accumulated data stored in the user's profile data 36, the routing software 34 determines the user prefers traveling on highways and predicts that the user will turn east on 1st Street 106 and then drive north on Highway 1 108 rather than continue driving north on Main Street 104. Numerous other factors in the profile data 36 may also come into play, such as the frequency in which the user drives on Main Street 104 versus Highway 1 108, the speed limits of these two routes compared with the user's typical speed, and so on.

Once the path has been predicted, the routing software 34 can provide the user with information about upcoming points of interest along the predicted path. In this example, the user can be alerted to the presence of a restaurant 110 and a gas station 112 located along 1st street 106 before coming to Highway 1 108. The routing software 34 can also provide traffic information or road conditions for the roads that route the user is predicted to follow. Finally, the personal navigation device 10 can ask if the user wishes to take the predicted path which is shown in a dotted line in FIG. 3. If the user does wish to take the predicted path, the routing software 34 will providing navigation instructions for guiding the user along the predicted path.

With the present invention, even if the user is traveling somewhere that the user has never traveled before, the user's past preferences for a certain type of road can still be used to suggest a path for the user to follow. For instance, the personal navigation device 10 can guide the user to the nearest highway if the user usually prefers to drive on highways.

In summary, the user's travel history is used to build the profile data 36, and the profile data 36 can be used to predict the most likely path that a user will take based on the user's driving preferences. The profile data 36 is constantly being collected and information about upcoming locations can continually be provided to the user, even when the user is not following an active route and receiving navigation instructions to a destination location. Therefore, the present invention encourages users to leave the personal navigation device 10 powered on whenever possible to both build up the profile data 36 as well as receive information about upcoming locations.

Those skilled in the art will readily observe that numerous modifications and alterations of the device and method may be made while retaining the teachings of the invention.

What is claimed is:

1. A method of utilizing a personal navigation device to predict paths taken by a user of the personal navigation device, the method comprising:
storing profile data for a user of the personal navigation device in a memory of the personal navigation device;
detecting a current path that the user is traveling on when the user has not inputted a destination location into the personal navigation device;
determining possible paths that the user may take based on the current path that the user is traveling on;
determining a most likely possible path that the user may take according to the profile data for the user; and
providing information about upcoming locations related to the most likely possible path.

2. The method of claim 1, wherein each user of the personal navigation device has separate profile data.

3. The method of claim 1, further comprising:
prompting the user to decide whether the user wishes to receive navigation instructions for the most likely possible path;
receiving a decision from the user; and
providing navigation instructions for guiding the user along the most likely possible path when the user decides to receive navigation instructions.

4. The method of claim 1, wherein profile data for the user comprises information about the user's preferred roads or preferred types of roads to travel on.

5. The method of claim 1, wherein profile data for the user comprises information about the user's preferred driving speeds.

6. The method of claim 1, wherein providing information about upcoming locations related to the most likely possible path comprises providing information about upcoming points of interest nearby the most likely possible path.

7. The method of claim 1, wherein providing information about upcoming locations related to the most likely possible path comprises providing information about upcoming roads along the most likely possible path.

8. The method of claim 1, wherein providing information about upcoming locations related to the most likely possible path comprises providing information about upcoming hazards along the most likely possible path.

9. The method of claim 1, wherein providing information about upcoming locations related to the most likely possible path comprises providing traffic alerts related to the most likely possible path.

10. The method of claim 1, wherein providing information about upcoming locations related to the most likely possible path comprises providing warnings about current driving behavior of the user based on driving behavior stored in the profile data for the user.

11. A personal navigation device utilized to predict paths taken by a user of the personal navigation device, the personal navigation device comprising:
a memory for storing profile data for a user of the personal navigation device;
routing software for detecting a current path that the user is traveling on when the user has not inputted a destination location into the personal navigation device, determining possible paths that the user may take based on the current path that the user is traveling on, determining a most likely possible path that the user may take according to the profile data for the user, and providing information about upcoming locations related to the most likely possible path; and
a processor for executing the routing software and for controlling operation of the personal navigation device.

12. The personal navigation device of claim 11, wherein each user of the personal navigation device has separate profile data.

13. The personal navigation device of claim 11, wherein the routing software prompts the user to decide whether the user wishes to receive navigation instructions for the most likely possible path, receives a decision from the user, and provides navigation instructions for guiding the user along the most likely possible path when the user decides to receive navigation instructions.

14. The personal navigation device of claim 11, wherein profile data for the user comprises information about the user's preferred roads or preferred types of roads to travel on.

15. The personal navigation device of claim 11, wherein profile data for the user comprises information about the user's preferred driving speeds.

16. The personal navigation device of claim 11, wherein providing information about upcoming locations related to the most likely possible path comprises providing information about upcoming points of interest nearby the most likely possible path.

17. The personal navigation device of claim 11, wherein providing information about upcoming locations related to the most likely possible path comprises providing information about upcoming roads along the most likely possible path.

18. The personal navigation device of claim 11, wherein providing information about upcoming locations related to the most likely possible path comprises providing information about upcoming hazards along the most likely possible path.

19. The personal navigation device of claim 11, wherein providing information about upcoming locations related to the most likely possible path comprises providing traffic alerts related to the most likely possible path.

20. The personal navigation device of claim 11, wherein providing information about upcoming locations related to the most likely possible path comprises providing warnings about current driving behavior of the user based on driving behavior stored in the profile data for the user.
